(19) United States
(12) Patent Application Publication
(10) Pub. No.: US 2008/0017259 A1
(43) Pub. Date: Jan. 24, 2008

(54) Pressure Cutoff Valve Unit and Hydraulic Circuit Equipped with It

(76) Inventors: Reinhold Schniederjan, Neu-Ulm (DE); Bernhard Adler, Neu-Ulm (DE); Markus Gepraegs, Ulm (DE)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/793,855

(22) PCT Filed: Dec. 13, 2005
(86) PCT No.: PCT/EP05/13386

§ 371 Date: Jul. 31, 2007

(30) Foreign Application Priority Data
Dec. 22, 2004 (DE) 10 2004 061 861.5

(51) Int. Cl. F15B 13/01

(52) U.S. Cl. 137/601.19; 137/561 R; 137/601.18

(57) ABSTRACT

The invention concerns a pressure cutoff valve unit (34) with a shuttle valve (36), which has a first input connection (39) and a second input connection (40), which it is possible to connect to an output depending on the pressures at the input connections (39, 40). The shuttle valve (36) has a shuttle valve closing element (45′), which in a first end position connects the first input connection (39) to the output and in a second end position connects the second input connection (40) to the output. The shuttle valve closing element (45′) can be locked in a position between the two end positions, and in this locked position the first input connection (39) is connected to the second input connection (40).

The invention concerns a pressure cutoff valve unit with a shuttle valve.

In hydraulic circuits, in which a load is driven by a hydraulic pump, it can happen that the set delivery volume of the pump exceeds the absorption volume of the load. Such a situation occurs, for instance, if the corresponding load is blocked, and can therefore absorb no more pressurising medium. The driven hydraulic pump nevertheless continues to deliver according to its set delivery volume into the delivery-side working pipe, in which the pressure rises accordingly.

The set delivery volume of the hydraulic pump depends on a control pressure, so that a reduction of the control pressure results in a reduction of the volume which the pump conveys. The consequence is a reduction of the delivery-side working pipe pressure. A valve unit which is intended to limit the pressure is known, for instance, from DE 195 12 143 C1. The pressure cutoff valve unit which is proposed has a pressure cutoff valve, which is arranged in a borehole together with a shuttle valve.

If the pressure on a measuring surface of the pressure cutoff valve exceeds a specified, adjustable limiting value, the pressure cutoff valve opens a connection between the control pressure pipe and a tank volume. As the opening increases, the available control pressure is thus reduced to the level of the tank pressure, and the hydraulic pump is adjusted in the direction of a reducing delivery volume. Via the shuttle valve, the greater of the pressures in the two working pipes is supplied to the corresponding measuring surface of the pressure cutoff valve. For this purpose, the shuttle valve has a valve piston, which is always freely movable.

The proposed pressure cutoff valve unit has the disadvantage that the pressure cutoff valve on the side of the measuring surface is permanently connected to either one or the other working pipe. On the contrary, no possibility of creating a connection between the two working pipes is created. Therefore, for the case of, for instance, towing a vehicle, in which pressurising medium is conveyed in the circuit by a hydraulic motor, a connection between the two working pipes must be created, to make towing possible. Without such a connection, the hydraulic motor would support itself on the hydraulic pump via the working pipes, and towing would be impossible.

The object of the invention is to create a pressure cutoff valve unit and a hydraulic circuit, in which the two working pipes can be connected to each other via a shuttle valve which is integrated in the pressure cutoff valve unit.

The object is achieved by a pressure cutoff valve unit with the features according to Claim 1 and by the hydraulic circuit with the features according to Claim 10.

To be able to reduce the control pressure when excessive pressures occur in the working pipes, the pressure cutoff valve unit according to the invention has a shuttle valve, through which a measuring surface of the pressure cutoff valve is connected to either one or the other working pipe. Therefore, the higher of the pressures which prevail in the two working pipes acts on the pressure cutoff valve. In addition to this position of the shuttle valve, which is set exclusively on the basis of the pressure conditions, another, lockable position is provided. In such a locked position, which is between the two end positions, the two input connections of the shuttle valve are connected to each other. In this way, a hydraulic short circuit of the hydraulic circuit is possible via the shuttle valve of the pressure cutoff valve unit.

In the case described above, that because of a defect, e.g. of a propulsion system, the vehicle must be towed with the engine not running, the pressurising medium which is pumped into the circuit by the hydraulic motor can now be pumped in the circuit without having to flow through the hydraulic pump.

In the subclaims, advantageous further developments of the pressure cutoff valve unit according to the invention are explained.

The invention is shown in simplified form in the drawings, and is explained in detail on the basis of the following description.

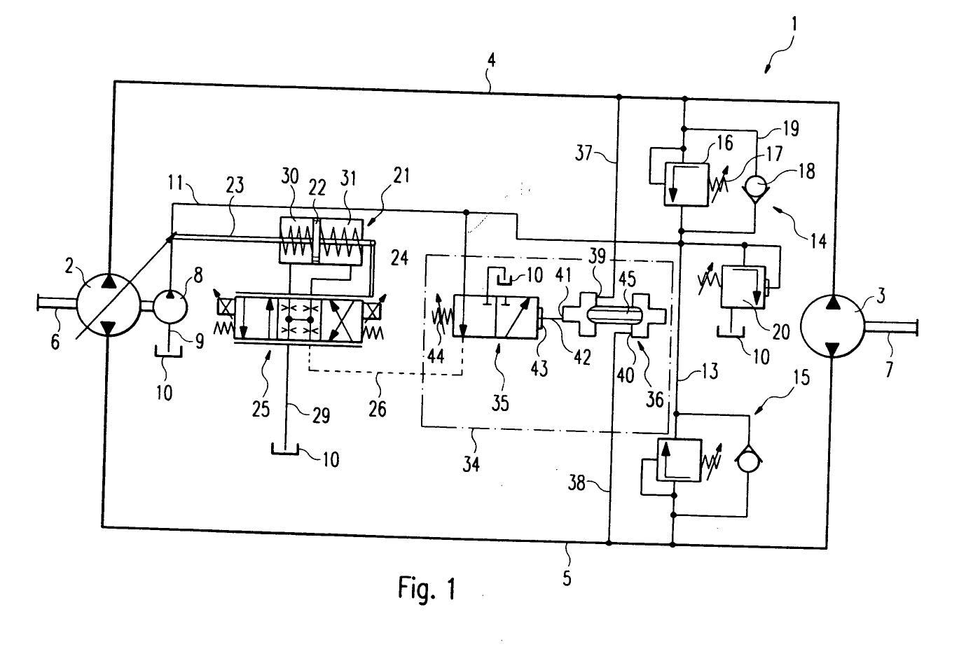

FIG. 1 shows a hydraulic circuit with a pressure cutoff valve unit according to the invention;

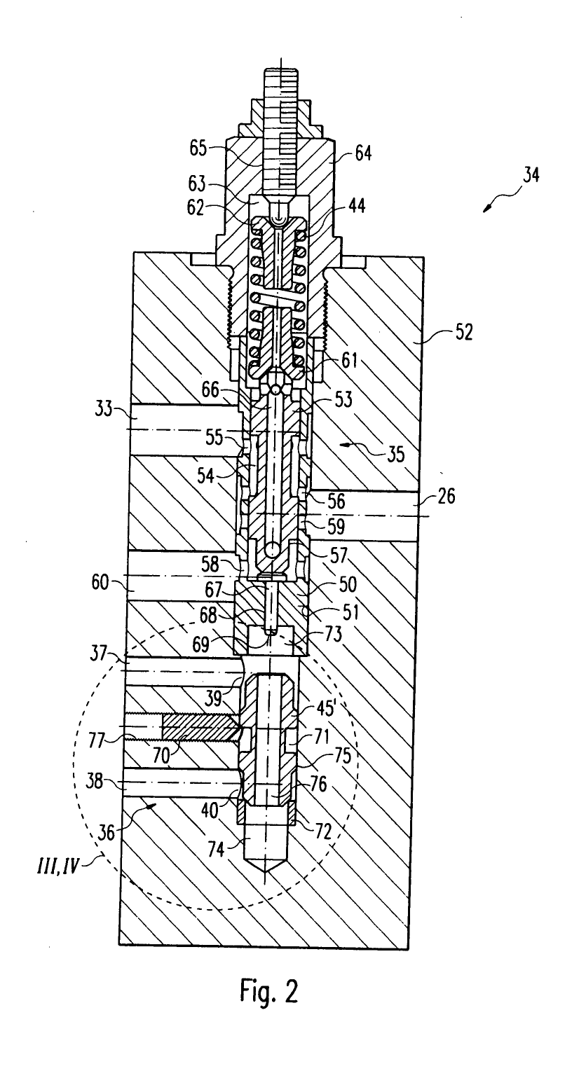

FIG. 2 shows an embodiment of a structural form of a pressure cutoff valve unit according to the invention;

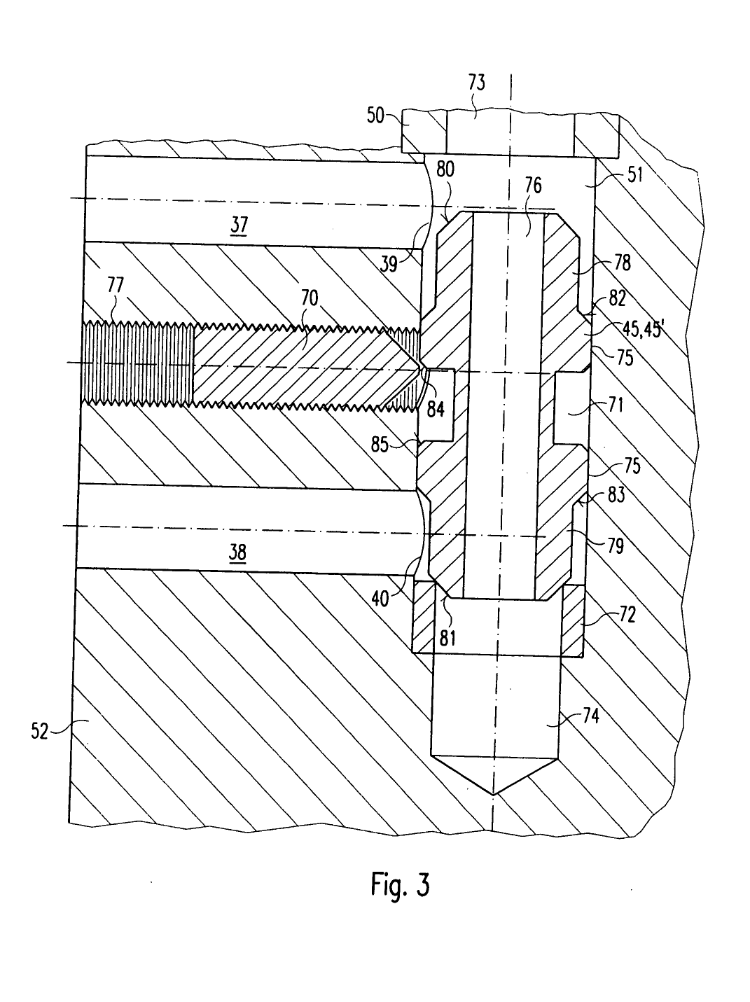

FIG. 3 shows an enlarged representation in Section III of FIG. 2 in an unlocked position; and

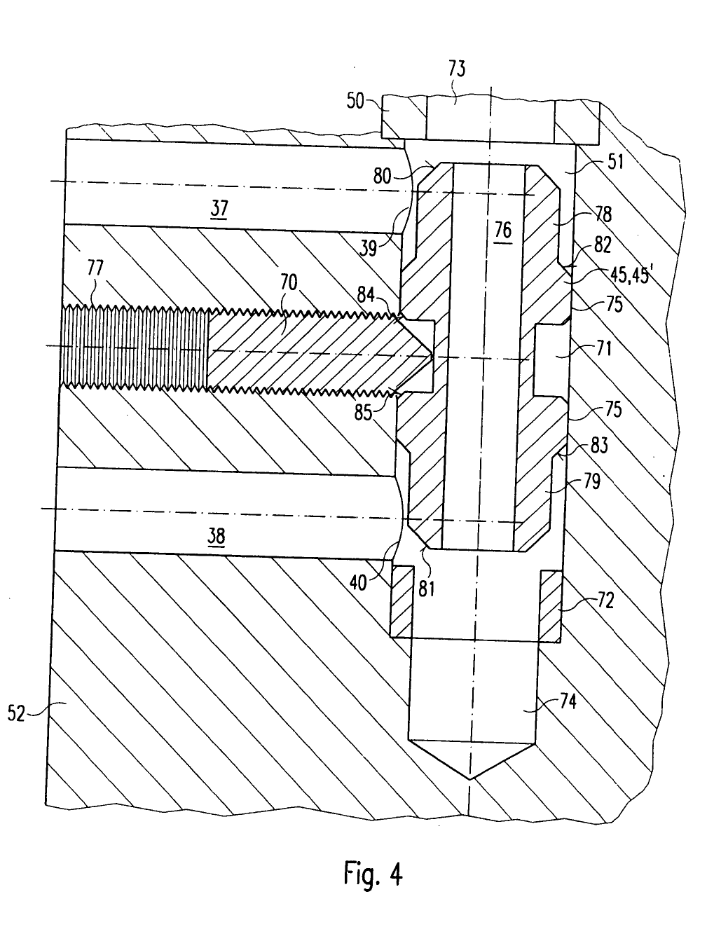

FIG. 4 shows an enlarged representation in Section IV of FIG. 2 in a locked position.

Before a structurally executed example of a pressure cutoff valve unit according to the invention is considered, first an example of a hydraulic circuit according to the invention will be explained. In a hydraulic circuit 1 of FIG. 1, a hydraulic pump 2 is connected to a hydraulic motor 3. The hydraulic pump 2 is implemented to be adjustable, and connected to the hydraulic motor 3 via a first working pipe 4 and a second working pipe 5. The hydraulic pump 2, with the first working pipe 4, the second working pipe 5 and the hydraulic motor 3 which is connected to it forms a closed hydraulic circuit. In the shown example, the hydraulic pump 2 and hydraulic motor 3 are preferably in the form of hydrostatic axial piston machines. The hydraulic pump 2 is adjustable, and provided for conveying pressurising medium in two directions. In contrast, the absorption volume of the hydraulic motor 3 is fixed, as a so-called fixed displacement motor.

The hydraulic circuit 1 is provided, for instance, for a vehicle drive of a mobile propulsion system. For this purpose, the hydraulic pump 2 is connected via a drive shaft 6 to an engine (not shown). The unshown engine is usually a diesel engine of the mobile propulsion system. The hydraulic motor 3 is connected via a drive shaft 7 to the vehicle drive. In the simple shown embodiment, only one hydraulic motor 3 is provided, and can be connected via the drive shaft 7, e.g. to a mechanical transmission which is connected downstream from it.

In addition to the hydraulic pump 2, which works in the closed hydraulic circuit 1, a feed pump 8 is provided, and is also connected to the drive shaft 6. The feed pump 8 is provided for conveying pressurising medium in only one direction. The feed pump 8 sucks pressurising medium out of a tank volume 10 via a suction pipe 9, and conveys it into a feed pipe 11.

During the startup of the hydraulic circuit 1, the working pipes 4 and 5 are to a large extent pressure-free. To feed pressurising medium into the system, the feed pipe 11 is connected to a connecting pipe 13. The connecting pipe 13 itself connects the first working pipe 4 to the second working pipe 5. In the connecting pipe 13, between the opening of the feed pipe 11 into the connecting pipe 13 and the first working pipe 4, a first feed valve unit 14 is arranged. Correspondingly, between the opening of the feed pipe 11 into the connecting pipe 13 and the second working pipe 5, a second feed valve unit 15 is arranged.

Since the structures of the first feed valve unit 14 and second feed valve unit 15 correspond, below only the first feed valve unit 14 is described in detail. The first feed valve unit 14 includes a pressure-limiting valve 16, which is held in a closed position by a spring 17. The pressure in the first working pipe 4 acts on the pressure-limiting valve 16 against the force of the spring 17. If this pressure in the working pipe 4 exceeds the threshold which is fixed by the spring 17, which is preferably in adjustable form, the pressure-limiting valve 16 in the connecting pipe 13 releases a connection in which a through flow is possible.

As well as the pressure-limiting valve 16, the first feed valve unit 14 has a non-return valve 18. The non-return valve 18 is formed in a bypass pipe 19, and opens in the direction towards the first working pipe 4. Therefore, by bypassing the pressure-limiting valve 16, as long as the pressure in the feed pipe 11 is higher than in the first working pipe 4, pressurising medium can be conveyed into the first working pipe 4 via the non-return valve 18 and bypass pipe 19.

The second feed valve unit 15 is constructed correspondingly, and thus makes it possible to fill the second working pipe 5. Simultaneously, via the first feed valve unit 14 and second feed valve unit 15, the first working pipe 4 and second working pipe 5 respectively are protected against a critical pressure increase in the working pipes 4 and 5. In this case, the appropriate pressure-limiting valve of the first or second feed valve unit 14 or 15 respectively opens, and releases the critical pressure of the working pipe 4 or 5 respectively into the connecting pipe 13.

To secure the feed system against excessively high pressures, the connecting pipe 13 is connected to a feed-pressure-limiting valve 20. If the pressure in the connecting pipe 13 exceeds a limiting value which can be set via the feed-pressure-limiting valve 20, the feed-pressure-limiting valve 20 opens and releases the connecting pipe 13 into the tank volume 10. Simultaneously, via the feed-pressure-limiting valve 20, the maximum feed pressure which is generated by the feed pump 8 is limited. Since the feed pump 8 is in the form of a fixed displacement pump, the quantity of fluid which the feed pump 8 conveys increases with the r.p.m. of the engine (not shown). By means of the feed-pressure-limiting valve 20, the level in the feed system, of which only the feed pipe 11 is shown in FIG. 1, is kept constant.

To adjust the conveying direction and conveyed volume of the hydraulic pump 2, an adjustment device 21 is provided. The adjustment device 21 includes a setting piston 22, the position of which is transmitted via a rod assembly 23 to the setting device of the hydraulic pump 2. The position of the rod assembly acts backwards via a connecting rod 24 onto a control valve 25.

The setting piston 22 of the adjustment device 21 is arranged in a cylinder. Depending on the forces which act on both sides of the setting piston 22, the setting piston 22 moves either to the left or to the right in FIG. 1. For this purpose, a control pressure is applied to the setting piston 22 via the control valve 25 from a control pressure pipe 26. Simultaneously, a lower pressure is applied to the opposite-facing surface of the setting piston 22, by the pressurising medium which acts there being carried away via a release pipe 29 into the tank volume 10. For this purpose, the setting piston 22 divides the cylinder of the adjustment device 21 into a first setting pressure space 30 and a second setting pressure space 31.

In a first end position of the control valve 25, the first setting pressure space 30 is connected to the control pressure pipe 26. Simultaneously, the second control pressure space 31 is connected via the release pipe 29 to the tank volume 10. Because of the different pressure conditions, the setting piston 22 is displaced to the right in FIG. 1. The setting movement is coupled back via the connecting rod 24 to the control valve 25, which then controls against the setting movement. In the described example, therefore, the control valve 25 is adjusted in the direction of its second end position, in which the first setting pressure space 30 is increasingly connected to the tank volume 10, whereas the second setting pressure space 31 is increasingly connected to the control pressure pipe 26. Thus, depending on the magnitude of the control pressure, an equilibrium state, with which the hydraulic pump 2 can be operated in any position, is set up.

As the maximum pressure in the control pressure pipe 26, the feed pressure which is present in the feed pipe 11, and which is supplied to the control pressure pipe 26 via a feed branch pipe 33 and a pressure cutoff valve 35, can be used. To activate the control valve 25, a force is applied to the control valve 25 in the direction of its first or second end position by two electromagnets. If no signal is present at the two electromagnets, the control valve 25 is brought back into its neutral position, in which all four connections of the control valve 25 are choked, and connected to each other, by two centring springs.

If blocking or strong braking of the hydraulic motor 3 occurs, a strong increase in the delivery-side working pipe 4 or 5 is the result. In such a case, irrespective of the control signals at the electromagnets, it must be possible to adjust the hydraulic pump 2 in the direction of minimum conveyed volume. For this purpose, a pressure cutoff valve unit 34 is provided in the hydraulic circuit 1.

The pressure cutoff valve unit 34 includes the pressure cutoff valve 35 and a shuttle valve 36. The shuttle valve 36 is connected via a first input pipe 37 and a second input pipe 38 to the first working pipe 4 and second working pipe 5 respectively. The first input pipe 37 opens on the shuttle valve 36 at a first input connection 39. Correspondingly, the second input pipe 38 opens on a second input connection 40 of the shuttle valve 36.

Depending on the pressure conditions in the first working pipe 4 and second working pipe 5, the higher pressure is supplied to an output 41 of the shuttle valve 36. The output 41 is connected via an output pipe 42 to a measuring surface 43 of the pressure cutoff valve 35. The pressure which acts on the measuring surface 43 exercises a hydraulic force on the pressure cutoff valve 35, counteracting a pressure cutoff valve spring 44. The pressure cutoff valve spring 44 acts on the pressure cutoff valve 35 in the direction of its idle position, in which the control pressure pipe 26 is connected to the feed pipe 11. In this way, via the pressure cutoff valve spring 44, which is preferably in adjustable form, an opening pressure of the pressure cutoff valve 35 can be set. Therefore, if the pressure in one of the two working pipes 4 or 5 exceeds the limiting value which is set in this way, the pressure cutoff valve 35 opens and releases a connection in which a through flow is possible from the control pressure pipe 26 to the tank volume 10.

Therefore, when critically high pressures occur in the first working pipe 4 or second working pipe 5, this critical pressure is supplied to the pressure cutoff valve 35 by moving a shuttle valve closing element 45 in the shuttle valve 36. The control pressure pipe 26 is released via the pressure cutoff valve unit 34. Correspondingly, in the first and second setting pressure spaces 30 and 31, which are connected to the control pressure pipe 26, the setting pressure which acts on the setting piston 22 falls. By two centring springs which are arranged in the first setting pressure space 30 and second setting pressure space 31, the setting piston 22 is moved against its original deflection, and thus the conveyed volume of the hydraulic pump 2 is reduced.

In FIG. 1, the shuttle valve closing element 45 is shown in a central position. In this central position, on the one hand a connection in which a through flow is possible is created between the first input connection 39 and the second input connection 40, but on the other hand a connection of the two input connections 39 and 40 to the output 41 is also created. If the hydraulic motor 3, which for instance is in the form of a fixed displacement motor, is rotated passively, the pressurising medium which it conveys is conveyed in the short-circuited hydraulic circuit. The pressurising medium does not have to be conveyed by the hydraulic pump 2 and a vehicle can easily be towed.

An example of a structural implementation of the pressure cutoff valve unit 34 according to the invention is shown in FIG. 2. The pressure cutoff valve unit 34 is shown in an axial arrangement of the pressure cutoff valve 35 with the shuttle valve 36. For this purpose, a stepped borehole 51 is formed in a valve support 52. A valve sleeve 50 is placed in the borehole 51. The valve sleeve 50 is itself provided with an axial recess, in which a pressure cutoff valve piston 53 is arranged so that it can move longitudinally.

Also, in the valve sleeve 50, control pressure input openings 55 and first control pressure output openings 56 are formed. If the valve sleeve 50 is in place, the control pressure input openings 55 connect the axial recess of the valve sleeve 50 to the feed branch pipe 33. The first control pressure output openings 56 connect the axial recess of the valve sleeve 50 to the control pressure pipe 26. In the shown embodiment, the control pressure pipe 26 and feed branch pipe 33 are formed as bored channels in the valve support 52.

The pressure cutoff valve piston 53 also has a surrounding recess 54. In the lower end position of the pressure cutoff valve piston 53 shown in FIG. 2, a connection in which a through flow is possible is created between the control pressure input openings 55 and the first control pressure output openings 56, via the gap which is formed between the surrounding recess 54 and the valve sleeve 50. Thus, in the shown idle position of the pressure cutoff valve 35, the feed branch pipe 33 is connected to the control pressure pipe 26.

At the lower end (in FIG. 2) of the pressure cutoff valve piston 53, a radially reduced section 57 is formed. The result, between the radially reduced section 57 and the valve sleeve 50, is a further space which is connected via tank connection openings 58 to a tank connection channel 60. If the pressure cutoff valve piston 53 is moved out of the idle position shown in FIG. 2, the radially reduced section 57 of the pressure cutoff valve piston 53 releases second control pressure output openings 59, so that the tank connection channel 60 is connected to the control pressure pipe 26. Simultaneously, the first control pressure output openings 56 are closed by the section, which is not reduced in radial extent, of the pressure cutoff valve piston 53. Thus the control pressure pipe 26 is released in the direction of the tank volume via the tank connection channel 60.

At the end of the radially reduced section 57 facing away from the pressure cutoff valve piston 53, a first spring bearing 61 rests on the pressure cutoff valve piston 53. A structurally equivalent second spring bearing is arranged in the opposite direction, and the pressure cutoff valve spring 44 is arranged between the first spring bearing 61 and the second spring bearing 62. The axial recess of the valve sleeve 50 is radially extended in the region facing the outside of the valve support 52, so that this extended region, together with a corresponding recess of a screw-in seal 64, forms a spring space 63. The screw-in seal 64 is adjacent to the face of the valve sleeve 50, and fixes it in the corresponding section of the borehole 51.

Through a through opening 65, which is formed in the screw-in seal 64, a counter-bearing is brought adjacent to the second spring bearing 62. The counter-bearing is, for instance, implemented as a headless pin, and its axial position is adjustable, so that the initial spring tension of the pressure cutoff valve spring 44 can be freely set. In this way, by setting the initial tension of the pressure cutoff valve spring 44, the opening pressure of the pressure cutoff valve 35 can be set. To bring the pressure cutoff valve piston 53 from the position shown in FIG. 2 into the position in which the control pressure pipe 26 is released into the tank connection channel 60, a measuring piston 67 is provided.

In the embodiment, the measuring piston 67 is essentially mushroom-shaped, the face of the radially reduced section 57 of the pressure cutoff valve piston 53 resting on the head of the measuring piston 67. The pressure cutoff valve piston 53 is held adjacent to the measuring piston 67 by the force of the pressure cutoff valve spring 44. The mushroom-shaped measuring piston 67 penetrates a measuring piston receiving borehole 68 in a direction facing away from the pressure cutoff valve piston 53. The measuring piston receiving borehole 68 is formed in the valve sleeve 50, in the axial direction, as an extension to the axial recess. On the face of the measuring piston 67 extending out of the measuring piston receiving borehole 68, a measuring surface 69 is formed. A hydraulic force can be applied to this measuring surface 69 against the force of the pressure cutoff valve spring 44. If the hydraulic force which acts there exceeds the oppositely acting force of the pressure cutoff valve spring 44, the pressure cutoff valve piston 53 is brought from the idle position shown in FIG. 2 into the previously described active position, in which the tank connection channel 60 is connected to the control pressure pipe 26.

As previously described in the explanation of FIG. 1, the higher of the pressures in the working pipes 4 and 5 is delivered via a shuttle valve 36 to the measuring surface 69.

For this purpose, the borehole 51 is brought so deeply into the valve support 52 that the shuttle valve closing element 45 can be inserted in the direction of the closed end of the borehole 51. In the shown embodiment, the shuttle valve closing element 45 is in the form of a valve piston 45′. The first input pipe 37 opens in the region of the borehole 51, which is connected directly to the valve sleeve 50. The opening of the first input pipe 37 into the borehole 51 corresponds to the first input 39 in FIG. 1.

Displaced in the direction towards the closed end of the borehole 51, the second input pipe 38 also opens into the borehole 51. The corresponding region of the opening is the second input connection 40.

The valve piston 45′ is shown in FIG. 2 in a position which it takes if the pressure in the first input pipe 37 is higher than the pressure in the second input pipe 38.

Because of the axial position of the valve piston 45′ shown there, the first input pipe 37 is connected via the first input 39 to a first pressure space 73. The first pressure space 73 is brought into the valve sleeve 50 as an extended region which is radially opposite the measuring piston receiving borehole 68, and simultaneously forms the output 41.

On the other hand, at the opposite end of the shuttle valve closing element 45, the valve piston 45′ rests on a sealing element 72. The valve piston 45′ has a guide section 75, with which the valve piston 45′ is guided in the borehole 51 in the region between the first input pipe 37 and the second input pipe 38. The diameter of the guide section 75 corresponds to the diameter of the borehole 51 in this region, so that in the region of the guide section 75, the valve piston 45′ acts with the borehole 51 to form a seal. The shuttle valve closing element 45, which is in the form of a valve piston 45′, has an axial borehole 76 extending from one face of the shuttle valve closing element 45 to the other face, as a channel connecting the volumes which are formed on both sides of the valve piston 45′. In this way, in the shown position, the first input 39 is connected to a second pressure space 74, which is formed at the closed end of the borehole 51. However, because the shuttle valve closing element 45 is adjacent to the sealing element 72, this second pressure space 74 is not connected to the second input 40.

Therefore, in the shown position of the shuttle valve 36, the pressure—which is supplied to the first working space 73 via the first input pipe 37—of the first working pipe 4 is exclusively applied to the measuring surface 69.

In the region of the guide section 75, a surrounding groove 71 is built into the valve piston 45′. The surrounding groove 71 reduces the radial dimensions of the valve piston 45′ so that a headless pin 70 can engage with the surrounding groove 71 as a locking element. The headless pin 70 is screwed into a threaded borehole 77, which is in the valve support 52 between the first input connection 37 and the second input connection 38. The headless pin 70 is pointed on its side facing in the direction of the shuttle valve closing element 45, so that when the headless pin 70 is screwed in, the axially movable valve piston 45′ of the shuttle valve 36 is moved out of its position shown in FIG. 2. As protection from contamination, and to prevent oil from leaking out, the threaded borehole is sealed by a suitable sealing closure, e.g. a seal lock sealing nut.

The width of the surrounding groove 71 in the axial direction of the valve piston 45′ corresponds at maximum to about the diameter of the headless pin 70. Thus when the headless pin 70 is fully screwed in, the shuttle valve closing element 45 can be locked in an exactly specified central position.

FIG. 3 shows an enlarged representation of the Section III of FIG. 2. In the enlarged representation, it can be seen that the valve piston 45′ has a first end 78 and a second end 79, which are each reduced in their radial measurements compared with the guide section 75. At each of the transitions from the faces to the first end 78 and second end 79, a phase is formed on the valve piston 45′. By this phase, a first sealing surface 80 and a second sealing surface 81 respectively are formed on the two ends of the valve piston 45′. In the position shown in FIG. 2, the second sealing surface 81 of the valve piston 45′ acts with a surrounding edge of the sealing element 72 to form a seal, and thus separates the second pressure space 74 from the second input connection 40.

On the other hand, if the valve piston 45′ is in its opposite end position, the first sealing surface 80 is adjacent to a corresponding edge (of the valve sleeve 50) which delimits the first pressure space 73. In this case, the second sealing surface 81 lifts away from the sealing element 72, so that the second input connection 40 is connected to the first pressure space 73 via the axial borehole 76 of the valve piston 45′. Thus the hydraulic force because of the pressure which prevails in the second working pipe 5, and is passed on via the axial borehole 76 into the first pressure space 73, acts on the measuring surface 69 of the measuring piston 67. At the transition from the first end 78 into the guide section 75 and from the second end 79 into the guide section 75, a first surface 82 and a second surface 83 respectively are formed.

Irrespective of the position of the valve piston 45′, the pressure of the first input pipe 37 is applied to the first surface 82. Correspondingly, likewise irrespective of the position of the valve piston 45′, the pressure of the second input pipe 38 is applied to the second surface 83. On the other hand, because of the pressure spaces 73 and 74, which are connected to each other via the axial borehole 76, the pressure which is also applied to the measuring surface 69 is applied to the other face of the shuttle valve closing element 45. Therefore, in the case of a pressure exchange in the working pipes, and thus also in the first input pipe 37 and second input pipe 38, merely because of the changing pressure difference, the valve piston 45′ is moved into the opposite end position.

As has already been explained in detail for FIG. 2, the shuttle valve closing element 45 can also be brought by a headless pin 70 into a specified, lockable position. This lockable position is between the two possible end positions of the shuttle valve closing element 45. Thus the first sealing surface 80 on the one hand and the second sealing surface 81 on the other hand are lifted from their respective sealing fits. Thus, via the axial borehole 76, the first pressure space 73 and second pressure space 74 are connected to each other. The first pressure space 73 is also connected to the first input pipe 37, and the second pressure space 74 is also connected to the second input pipe 38. Thus the two input pipes 37 and 38 and thus also the two working pipes 4 and 5 are short-circuited to each other through the locked shuttle valve closing element 45.

To be able to bring the shuttle valve closing element 45 into this locked position, a surrounding groove 71 is formed, in the way described above, in the region of the guide section 45. At the transition of the surrounding groove 71 into the guide section 75, a first bevel 84 and a second bevel 85 respectively are formed on the valve piston 45′. By means of the first bevel 84 and second bevel 85, the forces which are required to move the shuttle valve closing element 45 axially by screwing in the headless pin 70 are reduced. The first bevel 84 and second bevel 85 each form a slide face, which can be moved without using much force along the surface of the pointed headless pin 70.

FIG. 4 shows the shuttle valve closing element 45 in the locked position which is reached by screwing in the headless pin 70. It should be noticed that the width of the surrounding groove 71 is dimensioned approximately so that it is equal at most to the diameter of the headless pin 70. Thus with the fully screwed-in headless pin 70, the axial position of the shuttle valve closing element 45 is exactly determined. In FIG. 4, it can well be seen that both the first sealing surface 80 and the second sealing surface 81 are lifted from their seats on the edge of the valve sleeve 50 and the edge of the sealing element 72 respectively. Thus, in the way described above, a connection between the first input pipe 37 and second input pipe 38 is created.

The free flow cross-sections between the first sealing surface 80 and second sealing surface 81 and their corresponding sealing seats must be chosen so that the flow which occurs when the vehicle is towed can pass through practically unhindered.

On the other hand, it is also possible, by forming a deliberate choke in this region, to deliberately prevent fully free rolling of the vehicle. Such a choke can also be set up, for instance, by dimensioning the axial borehole 76 as a choke point of the shuttle valve closing element 45. If a choke is not to take place, the diameter must be chosen to be correspondingly large.

The arrangement with a shuttle valve which is used in an axial extension of the pressure cutoff valve is specially advantageous. However, with different structural factors, a different arrangement may be necessary, for instance if the given structural depth is insufficient. The choke valve can also be arranged displaced relative to the pressure cutoff valve. The output of the shuttle valve is then connected via a channel which runs in the valve support.

Instead of the arrangement in the borehole or a separate borehole, the valve sleeve of the pressure cutoff valve can also be of such a form in the lower region that it can receive the shuttle valve closing element. In this case, the result is simplified assembly, since the pressure cutoff valve unit can be pre-assembled and then inserted into the valve support as a cartridge.

The implementation according to the invention of a pressure cutoff valve unit makes hydraulic short-circuiting of the circuit easily possible. Thus, for instance, the high pressure valves of a hydrostatic drive can be introduced without a bypass function.

The invention is not restricted to the presented embodiments. All described elements can be arbitrarily combined with each other.

1. Pressure cutoff valve unit with a shuttle valve, which has a first input connection and a second input connection, which it is possible to connect to an output depending on the pressures at the input connections,
the shuttle valve having a shuttle valve closing element, which in a first end position connects the first input connection to the output and in a second end position connects the second input connection to the output,
wherein
the shuttle valve closing element can be locked in a position between the two end positions, and in this locked position the first input connection is connected to the second input connection.

2. Pressure cutoff valve unit according to claim 1,
wherein
in the locked position, the output is connected to the first and second input connections.

3. Pressure cutoff valve unit according to claim 1,
wherein
in the locked position, the first input connection is connected to a first pressure space and the second input connection is connected to a second pressure space.

4. Pressure cutoff valve unit according to claim 1,
wherein
the shuttle valve closing element can be mechanically blocked by a locking element.

5. Pressure cutoff valve unit according to claim 4,
wherein
the locking element is in the form of a headless pin, to engage with a recess of the shuttle valve closing element.

6. Pressure cutoff valve unit according to claim 4,
wherein
the shuttle valve closing element is in the form of a valve piston, on which a surrounding groove is formed to work with the locking element.

7. Pressure cutoff valve unit according to claim 6,
wherein
the first pressure space is connected to the second pressure space via a connecting channel which is formed in the valve piston.

8. Pressure cutoff valve unit according to claim 1,
wherein
the shuttle valve closing element to form the shuttle valve is arranged in a borehole which receives the pressure cutoff valve in an axial extension of the pressure cutoff valve.

9. Pressure cutoff valve unit according to claim 1,
wherein
the shuttle valve closing element to form the shuttle valve is arranged in a valve sleeve of a pressure cutoff valve.

10. Hydraulic circuit with a first working pipe and a second working pipe, the first working pipe being connected to a first input connection, and the second working pipe being connected to a second input connection, of a shuttle valve of a pressure cutoff valve unit,
it being possible to connect the first input connection or second input connection to an output depending on the pressures at the input connections,
and the shuttle valve having a shuttle valve closing element, which in a first end position connects the first input connection to the output and in a second end position connects the second input connection to the output,
wherein
the shuttle valve closing element can be locked in a position between the two end positions, and in this locked position the first input connection is connected to the second input connection.
